(19) United States
(12) Patent Application Publication
(10) Pub. No.: US 2025/0218712 A1
(43) Pub. Date: Jul. 3, 2025

(54) GRAVITY SWITCH STRUCTURE

(71) Applicant: KITCHEN MAMA LLC, WILMINGTON, DE (US)

(72) Inventors: Shih-Chuan CHUANG, Wilmington, DE (US); Ching-Hsiu YAO, Wilmington, DE (US); Mao-Xi LIU, Wilmington, DE (US)

(73) Assignee: KITCHEN MAMA LLC, WILMINGTON, DE (US)

(21) Appl. No.: 18/420,032

(22) Filed: Jan. 23, 2024

(30) Foreign Application Priority Data
Dec. 29, 2023 (TW) 112214399

(51) Int. Cl. H01H 35/02; A47J 42/44; A47J 42/46

(52) U.S. Cl. CPC H01H 35/02; A47J 42/44; A47J 42/46

(57) ABSTRACT

A gravity switch structure includes a mount having a tube and an installation plate, a terminal assembly, and a slider having a column provided at the bottom end thereof with a press head. The tube has a column hole, in which the column is disposed, and a bottom having a through hole and a stopping portion where the bottom end of the column is abutted. The terminal assembly is disposed on the installation plate, having first and second electrically conductive members extending below the through hole. The column is movable axially, enabling the press head to pass through the through hole to be abutted against the second electrically conductive member to bend it elastically to contact the first electrically conductive member. The gravity switch structure is easily assembled, highly adaptable, and the stopping portion prevents the slider from directly impacting the second electrically conductive member.

### BACKGROUND OF THE INVENTION

### 1. Field of the Invention

The present invention relates to the switch technology field and more particularly, to a gravity switch structure.

### 2. Description of the Related Art

It is well known that the traditional gravity switch structure disposed in an electric pepper grinder, such as those disclosed in U.S. Pat. Nos. 6,830,205 and 7,077,347, includes a through hole directly provided in a battery seat for accommodating a slider, and the battery seat is installed with two electrically conductive leads spanning across the opening of the through hole and forming an open circuit in the normal state. When the slider presses on the two electrically conductive leads to make the two electrically conductive leads in contact with each other or make the two electrically conductive leads electrically connected with the slider made of electrically conductive metal, the two electrically conductive leads are electrically connected with each other. In this way, the electric pepper grinder is automatically power-on when being used upright, and automatically power-off when being placed upside down to result in that the slider is separated from the two electrically conductive leads.

Although the gravity switch structure disclosed in the aforementioned patents can attain the predicted effect, the above-described gravity switch structure is designed in coordination with the battery seat which has special shape and structure for accommodating the battery, resulting in limited applicability. Besides, the electrically conductive leads are welded to electrically conductive terminals provided on the battery seat, so the assembly is inconvenient. In addition, the two electrically conductive leads directly bear the impact and weight of the slider, which is liable to cause the electrically conductive leads elastic fatigue and the resulting contact failure.

### SUMMARY OF THE INVENTION

The present invention has been accomplished in view of the above-noted circumstances. It is a primary objective of the present invention to provide a gravity switch structure which has modularized configuration design and the resulting relatively higher applicability.

It is another objective of the present invention to provide a gravity switch structure which is convenient and easy in assembly.

It is still another objective of the present invention to provide a gravity switch structure which has a specially designed stopping mechanism to prevent the electrically conductive leads from direct impact by the slider.

To attain the above objectives, the present invention provides a gravity switch structure which includes a mount, a terminal assembly, and a slider. The mount has a tube, and an installation plate integrally extending from the outer periphery of the tube outwardly and downwardly. The tube has a column hole, and a bottom having a through hole. The through hole and the column hole communicate with each other, and the inner wall surface of the bottom forms a stopping portion. The terminal assembly is disposed on the installation plate, and has a first electrically conductive member and a second electrically conductive member, which extend below the through hole and are separated from each other. The slider has a column, and a press head located at a bottom end of the column. The column is disposed in the column hole in an axially movable manner, enabling the press head to pass through the through hole to be abutted against the second electrically conductive member in a way that the second electrically conductive member is elastically bent to contact the first electrically conductive member, and the bottom end of the column is stoppable against the stopping portion.

By the above-described technical features, the mount, the terminal assembly and the slider are combined into a module, so that through the installation plate, the gravity switch structure can be easily installed in various types of electric tools for use, thereby enhancing its applicability. Besides, the gravity switch structure of the present invention is simple in structure, thereby convenient and easy in assembly. In addition, the gravity switch structure of the present invention has the stopping portion to bear the slider, preventing the slider from directly impacting the second electrically conductive member, or preventing the first and second electrically conductive members from directly bearing all the weight of the slider.

Preferably, the second electrically conductive member has an electrically conductive elastic sheet, and an abutment portion located at an end of the electrically conductive elastic sheet and protruding from the electrically conductive elastic sheet. As a result, the press head can be abutted against the abutment portion to ensure that the press head can press on the second electrically conductive member positively.

Preferably, the abutment portion may be a hollow frame, so as to be reduced in weight and able to be elastically deformed when bearing relatively larger pressure.

Preferably, the installation plate has a positioning pillar. The terminal assembly has a terminal seat. The first electrically conductive member and the second electrically conductive member are fixed to the terminal seat separately from each other. The terminal seat has a positioning hole. The positioning hole is sleeved onto and positioned at the positioning pillar. In this way, the terminal assembly can be fixedly installed on the installation plate fast, thereby enhancing the assembly efficiency.

Preferably, the installation plate has a positioning hole. The terminal seat has a positioning pillar. The positioning hole of the installation plate is sleeved onto and positioned at the positioning pillar of the terminal seat. In this way, the terminal assembly and the installation plate can be positioned and fixed to each other fast, thereby raising the assembly efficiency.

Preferably, the tube has an upward opening communicating with the column hole. In this way, the upward opening may serve as a socket hole for fixedly fitting onto an insert fastener of another object, so that the gravity switch structure can be fixedly installed on other objects easily.

Preferably, the installation plate has an engagement block protruding downwardly. In this way, the engagement block can be inserted into a fitting hole of another object, so that the gravity switch structure can be fixedly installed on other objects easily.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The gravity switch structure 1 provided by the present invention will be further illustrated in the following embodiment and the accompanying drawings, and wherein:

FIG. 1 is an exploded perspective view of an electric pepper grinder, illustrating a power module wherein a gravity switch structure according to a preferred embodiment of the present invention is applied;

FIG. 2 is a top view of the power module shown in FIG. 1;

FIG. 3 is a sectional view taken along the line 3-3 in FIG. 2;

FIG. 4 is a sectional view taken along the line 4-4 in FIG. 2;

FIG. 5 is an assembled perspective view showing that the gravity switch structure according to the preferred embodiment of the present invention is installed on a lower shell of the power module;

FIG. 6 is a perspective view showing the lower shell and other components of the power module;

FIG. 7 is a perspective view showing an upper shell of the power module;

FIG. 8 is an assembled perspective view of the gravity switch structure according to the preferred embodiment of the present invention;

FIG. 9 is an assembled perspective view of the gravity switch structure according to the preferred embodiment of the present invention, which is viewed from another direction;

FIG. 10 is an exploded perspective view of the gravity switch structure according to the preferred embodiment of the present invention;

FIG. 11 is an exploded perspective view of the gravity switch structure according to the preferred embodiment of the present invention, which is viewed from another direction;

FIG. 12 is a planar assembled sectional view of the gravity switch structure according to the preferred embodiment of the present invention;

FIG. 13 is a planar sectional view of a mount of the gravity switch structure according to the preferred embodiment of the present invention; and

FIG. 14 is similar to FIG. 3, but showing the power module in an inclined status.

### DETAILED DESCRIPTION OF THE INVENTION

First of all, it is to be mentioned that the technical features provided by the present invention are unlimited to the specific structure, usage and application thereof described in the detailed description of the invention. It should be understood by those skilled in the related art that all the terms used in the content of the specification are for illustrative description. The directional terms mentioned in this specification, such as ‘front’, ‘upper’, ‘lower’, ‘rear’, ‘left’, ‘right’, ‘top’, ‘bottom’, ‘inside’, and ‘outside’, are also just for illustrative description on the basis of normal usage direction, not intended to limit the claimed scope.

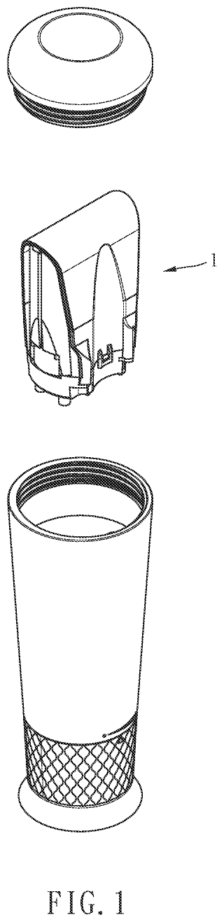

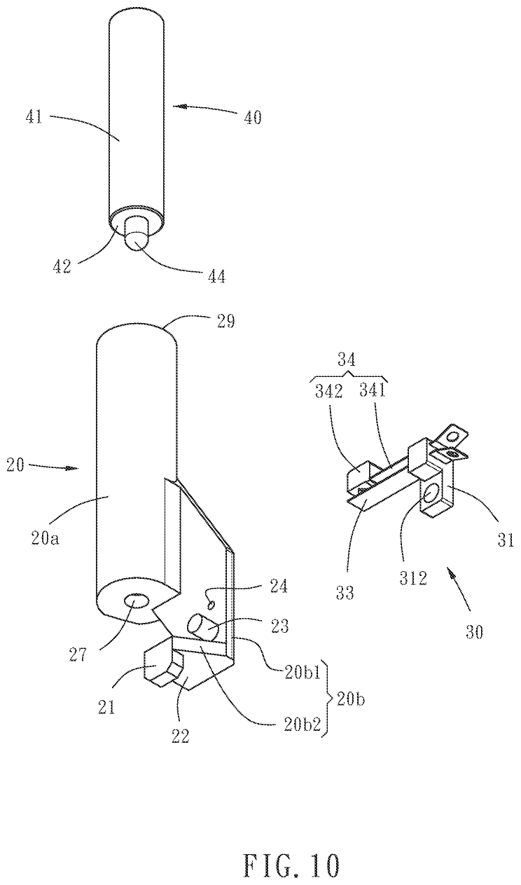

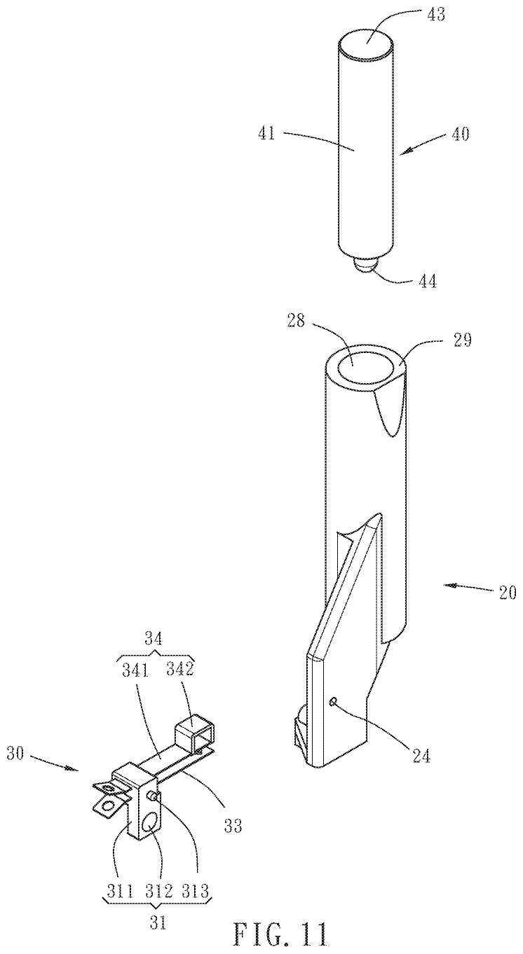

Referring to FIG. 1, FIG. 1 is an exploded perspective view of an electric pepper grinder, showing a power module 1 for the electric pepper grinder. Referring to FIG. 10, a gravity switch structure according to a preferred embodiment of the present invention is shown in FIG. 10, primarily including a mount 20, a terminal assembly 30 and a slider 40. The structure and features of the present invention will be specified in the following by an instanced implementation of applying the gravity switch structure of the present invention in the power module 1 of the electric pepper grinder. However, the present invention is unlimited thereto, which means it may be applied to other electric tools for electrically connecting the electric tools' battery and motor, and so on.

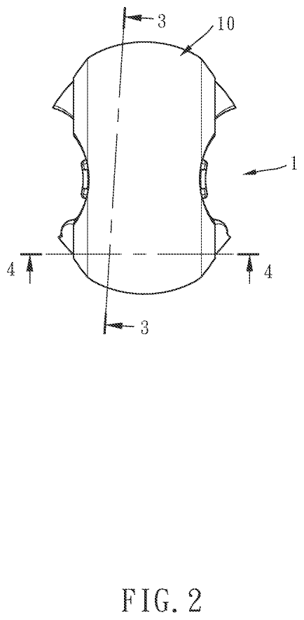

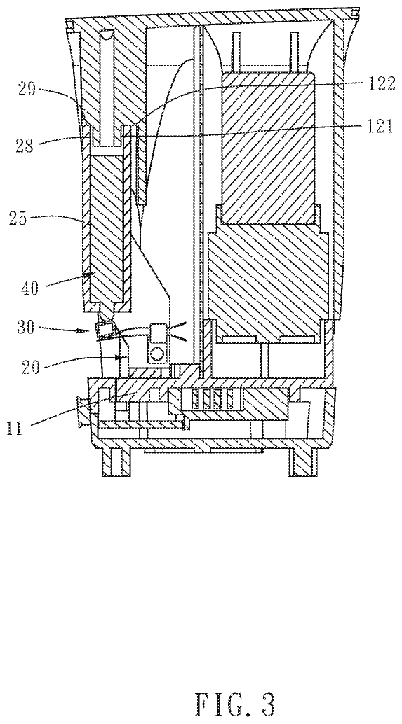

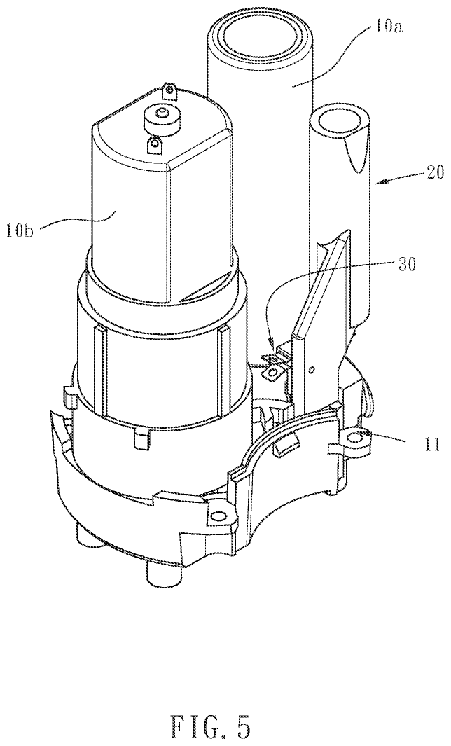

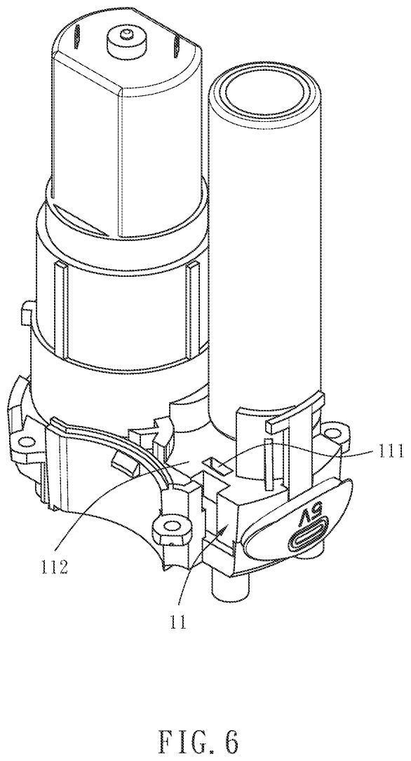

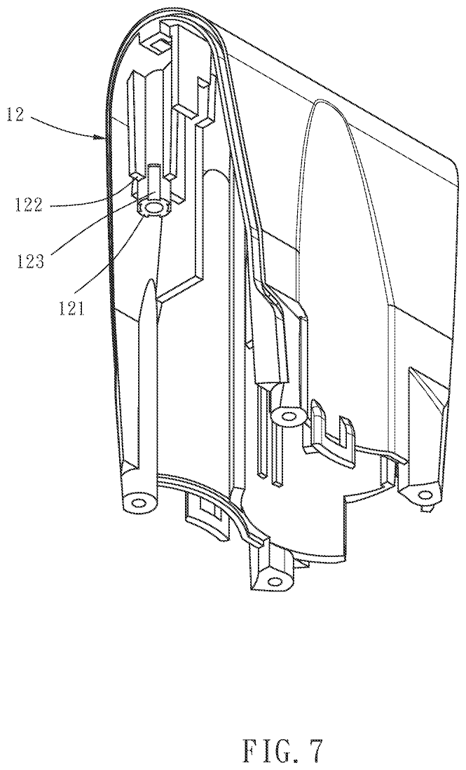

As shown in FIG. 2 to FIG. 7, the power module 1 primarily includes a housing 10, and components disposed in the housing 10, such as a motor 10a, a battery 10b and a transmission mechanism (not shown). In practice, the housing 10 is an assembly of a lower shell 11 and an upper shell 12, which are connected with each other in a buckled manner. As shown in FIG. 6, the lower shell 11 has a first lower connecting portion 111 and a first lower abutting portion 112. As shown in FIGS. 3, 4 and 7, the upper shell 12 has a first upper connecting portion 121, a plurality of gas releasing grooves 123, and a plurality of first upper abutting portions 122. In this embodiment, the first lower connecting portion 111 is a rectangular socket hole. The first lower abutting portion 112 is approximately a plane. The first upper connecting portion 121 is rod-shaped. Each gas releasing groove 123 is formed on the outer peripheral surface of the first upper connecting portion 121. Each first upper abutting portion 122 is rib-shaped and located on the outer periphery of the first upper connecting portion 121.

As shown in FIG. 3 to FIG. 5, the gravity switch structure, which includes the mount 20, the terminal assembly 30 and the slider 40, is fixedly clamped between the first upper connecting portion 121 and the first lower connecting portion 111. The detailed structure and combining relation of the components of the gravity switch structure are described in the following.

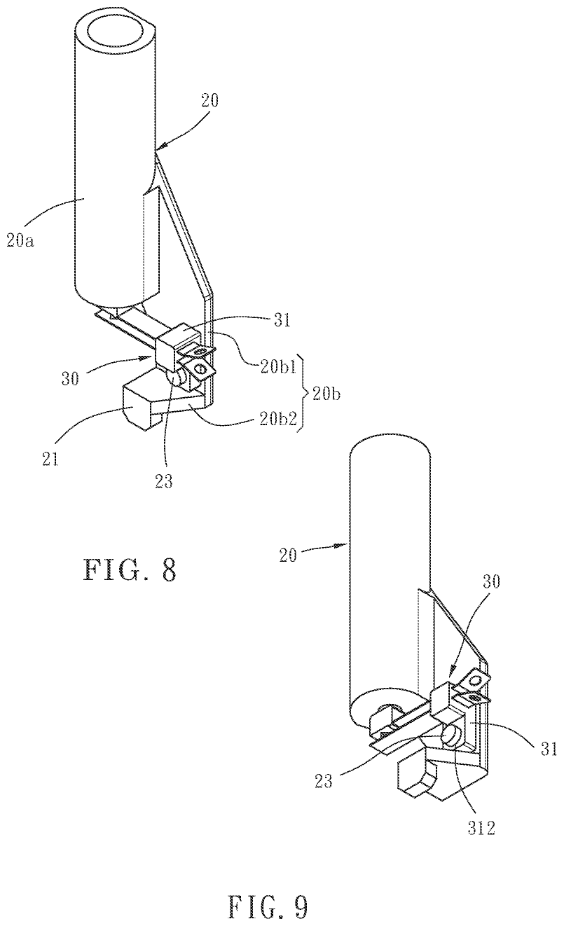

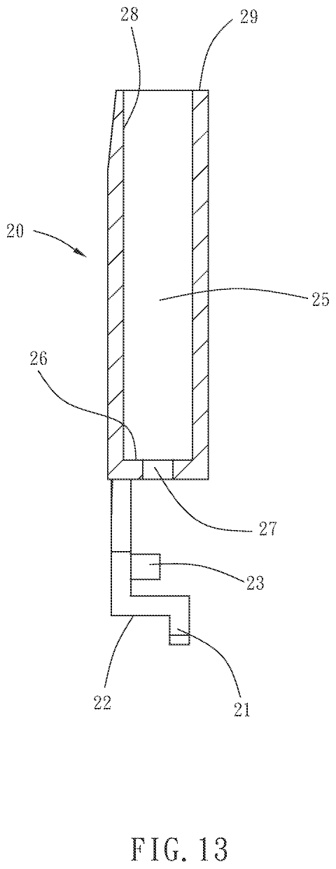

Referring to FIG. 8 to FIG. 11, upper and lower parts of the mount 20 are fixedly coupled with the first upper connecting portion 121 and the first lower connecting portion 111 respectively. Specifically speaking, the mount 20 has a tube 20a, and an installation plate 20b integrally extending from the outer periphery of the tube 20a outwardly and downwardly. Wherein, the installation plate 20b has a vertical plate 20b1 connected to the tube 20a, a horizontal plate 20b2 horizontally extending from the bottom end of the vertical plate 20b1, a second lower connecting portion 21 formed by an engagement block protruding downwardly from an end of the horizontal plate 20b2, a second lower abutting portion 22 formed on the bottom surface of the horizontal plate 20b2, and a first installation portion 23 and a first positioning portion 24, which are located on the vertical plate 20b1. In this embodiment, the first installation portion 23 and the first positioning portion 24 are implemented by a positioning pillar and a positioning hole respectively. Besides, as shown in FIG. 13, the tube 20a has a cylindrical column hole 25 extending downwardly, a through hole 27 located at the bottom of the tube 20a and communicating with the column hole 25, a stopping portion 26 formed on the inner wall surface of the bottom of the tube 20a, a second upper connecting portion 28 formed by the upward opening located on the top edge of the tube 20a, and a second upper abutting portion 29 formed by the top end surface of the tube 20a. During the assembly, the second lower connecting portion 21 is fixedly inserted into the first lower connecting portion 111 of the housing 10, making the second lower abutting portion 22 firmly abutted on the first lower abutting portion 112 of the housing 10. Besides, the second upper connecting portion 28 is sleeved onto the first upper connecting portion 121 of the housing 10, and the second upper abutting portion 29 is firmly abutted on the first upper abutting portion 122 of the housing 10.

The terminal assembly 30 is fixedly disposed on the vertical plate 20b1 of the installation plate 20b of the mount 20. Specifically speaking, the terminal assembly 30 has a terminal seat 31, a first electrically conductive member 33, and a second electrically conductive member 34. Wherein, the first electrically conductive member 33 and the second electrically conductive member 34 are separately embedded and covered in the terminal seat 31, and extend right below the through hole 27 parallel to each other and separately from each other. The first electrically conductive member 33 and the second electrically conductive member 34 can be deformed elastically and are electrically connected with two contacts of a circuit (not shown) respectively. Besides, the terminal seat 31 has a seat block 311, a second installation portion 312, and a second positioning portion 313. In this embodiment, the second installation portion 312 and the second positioning portion 313 are implemented by a positioning hole and a positioning pillar respectively. During the assembly, one side of the seat block 311 is abutted on the vertical plate 20b1 of the mount 20, the second installation portion 312 is fixedly sleeved onto the first installation portion 23 of the mount 20, and the second positioning portion 313 is fixedly inserted into the first positioning portion 24 of the mount 20. In this way, by the coupling of two sets of positioning pillar and positioning hole, the terminal assembly 30 can be fixedly combined with the mount 20 fast, and will not rotate relative to the mount 20. However, the present invention is unlimited thereto. In addition, the second electrically conductive member 34 has an electrically conductive elastic sheet 341, and an abutment portion 342 located at an end of the electrically conductive elastic sheet 341 and protruding from the electrically conductive elastic sheet 341. In this embodiment, the abutment portion 342 is implemented by a hollow frame so as to be reduced in weight and able to be elastically deformed when bearing relatively larger pressure, but the present invention is unlimited thereto.

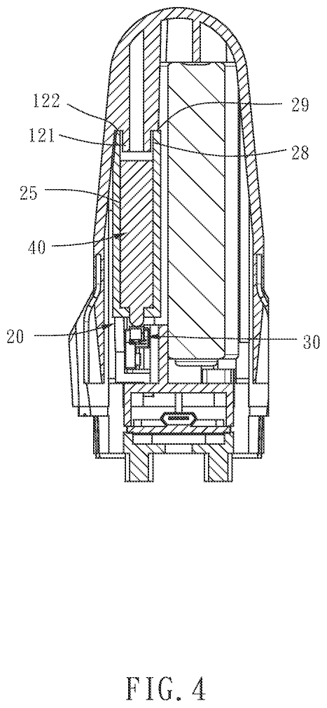

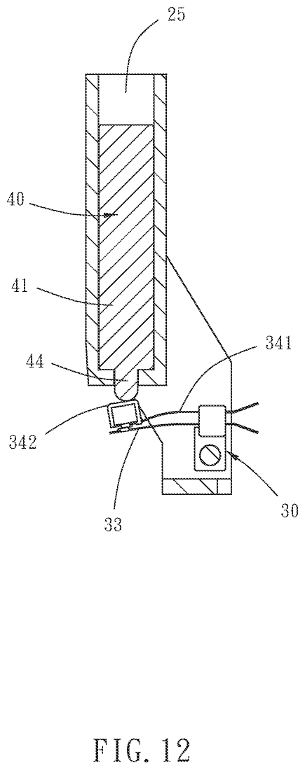

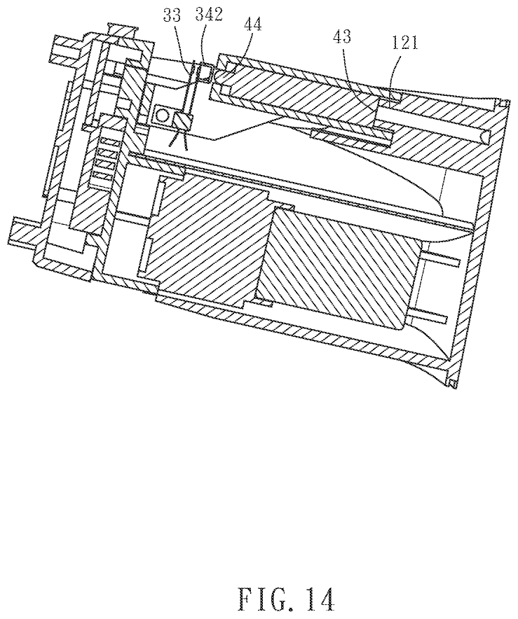

The slider 40 is disposed in the tube 20a of the mount 20. Specifically speaking, the slider 40 has a column 41 and a press head 44. The column 41 has a bottom end 42 and a top end 43, and the press head 44 extends from the center of the bottom end 42 of the column 41 outwardly. During the assembly, the column 41 is disposed in the column hole 25 of the mount 20 in an axially movable manner. When the gravity switch structure is upright or inclined to a certain angle, making the column 41 affected by gravity to fall downward, the press head 44 passes through the through hole 27 to be abutted against the abutment portion 342 of the second electrically conductive member 34 to make the second electrically conductive member 34 elastically bend to contact the first electrically conductive member 33 and thereby electrically connected therewith (as shown in FIG. 12), so as to make the circuit closed. Meanwhile, the bottom end 42 is stopped on the stopping portion 26 of the tube 20a of the mount 20, and the top end 43 is away from the first upper connecting portion 121 for a certain distance (as shown in FIG. 4). When the gravity switch structure is placed upside down vertically or inclinedly to a certain angle (as shown in FIG. 14), the column 41 is also affected by gravity to slide toward the top end surface of the tube 20a, causing the press head 44 to separate from the abutment portion 342 of the second electrically conductive member 34, such that the second electrically conductive member 34 will elastically restore to the state of separation from the first electrically conductive member 33 and thereby not electrically connected therewith, so as to make the circuit opened. Meanwhile, the top end 43 of the column 41 is abutted and stopped on the first upper connecting portion 121. In addition, when the slider 40 slides, the gas releasing grooves 123 formed on the outer peripheral surface of the first upper connecting portion 121 can reduce the affection of gas seal on the slider 40, resulting in fast and positive movement.

It can be known from the above description that in the gravity switch structure provided by the present invention, the mount 20, the terminal assembly 30 and the slider are combinedly formed as a module, which can be easily installed into the housing of various types of electric tools, such as the housing 10 of the power module 1 of the electric pepper grinder, for use, thereby achieving higher applicability. Besides, the mount 20 and the terminal assembly 30 are fixed to each other in an insertion-coupling manner, and the slider 40 is installed in the tube 20a of the mount 20. The whole structure is simple, and the assembly is convenient and easy, so that the assembly efficiency is relatively higher. In addition, the socket hole provided at the upper end of the tube 20a of the mount 20, i.e. the second upper connecting portion 28, can be fixedly fit onto an insert fastener of other objects. Alternatively, the engagement block provided on the installation plate 20b, i.e. the second lower connecting portion 21, can be inserted into a fitting hole of other objects. Therefore, the gravity switch structure of the present invention can be fixedly installed on another object, such as the electric pepper grinder or other electric tools, without the aid of tools or fastening members like screws, thereby having the advantages of easy assembly and high adaptability. Besides, the gravity switch structure of the present invention is provided with the stopping portion 26 to limit the displacement of the slider 40, thereby preventing the press head 44 of the slider 40 from directly impacting the second electrically conductive member 34. Meanwhile, the stopping portion 26 is adapted for the bottom end 42 of the column 41 of the slider 40 to be abutted thereon, thereby preventing the first and second electrically conductive members 33 and 34 from directly bearing all the weight of the slider 40. In this way, the first and second electrically conductive members 33 and 34 may have an enhanced life time, and the first and second electrically conductive members 33 and 34 are ensured to function normally.

Based on the spirit of the design of the present invention, except for the above instanced description, the gravity switch structure provided by the present invention may have other variations. For example, the second electrically conductive member 34 of the terminal assembly 30 may have no such abutment portion 342, and the electrically conductive elastic sheet 341 of the second electrically conductive member 34 is directly pressed by the press head 44. Alternatively, the abutment portion 342 is unlimited to the hollow frame configuration disclosed in the above embodiment, but may be a solid protrusion. Besides, the installation plate 20b is also unlimited to the plate or sheet shape disclosed in the above embodiment, but may be formed in any shape adapted for the terminal assembly 30 to be installed thereon in a way that the first and second electrically conductive members 33 and 34 are suspended below the through hole 27. In addition, the mount 20 may be configured without the socket hole (second upper connecting portion 28) and/or engagement block (second lower connecting portion 21), but installed on another object in other manners such as a tight fit manner, a hook manner, and so on.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A gravity switch structure comprising:
a mount having a tube and an installation plate integrally extending from an outer periphery of the tube outwardly and downwardly, the tube having a column hole and a bottom provided with a through hole, the through hole and the column hole communicating with each other, an inner wall surface of the bottom forming a stopping portion;
a terminal assembly disposed on the installation plate, the terminal assembly having a first electrically conductive member and a second electrically conductive member, which extend below the through hole and are separated from each other; and
a slider having a column and a press head located at a bottom end of the column, the column being disposed in the column hole in an axially movable manner, enabling the press head to pass through the through hole to be abutted against the second electrically conductive member in a way that the second electrically conductive member is elastically bent to contact the first electrically conductive member, and the bottom end of the column is stoppable against the stopping portion.

2. The gravity switch structure as claimed in claim 1, wherein the second electrically conductive member has an electrically conductive elastic sheet, and an abutment portion located at an end of the electrically conductive elastic sheet and protruding from the electrically conductive elastic sheet; the press head is abutted against the abutment portion.

3. The gravity switch structure as claimed in claim 2, wherein the abutment portion is a hollow frame.

4. The gravity switch structure as claimed in claim 1, wherein the installation plate has a positioning pillar; the terminal assembly has a terminal seat; the first electrically conductive member and the second electrically conductive member are fixed to the terminal seat separately from each other; the terminal seat has a positioning hole; the positioning hole is sleeved onto and positioned at the positioning pillar.

5. The gravity switch structure as claimed in claim 4, wherein the installation plate has a positioning hole; the terminal seat has a positioning pillar; the positioning hole of the installation plate is sleeved onto and positioned at the positioning pillar of the terminal seat.

6. The gravity switch structure as claimed in claim 1, wherein the tube has an upward opening communicating with the column hole.

7. The gravity switch structure as claimed in claim 6, wherein the installation plate has an engagement block protruding downwardly.

8. The gravity switch structure as claimed in claim 1, wherein the installation plate has an engagement block protruding downwardly.
